(19) United States
(12) Patent Application Publication
(10) Pub. No.: US 2006/0213135 A1
(43) Pub. Date: Sep. 28, 2006

(54) Installation method and system for a closure unit

(75) Inventors: Gary L. Mathes, Pella, IA (US); Cordell R. Burton, Pella, IA (US)

Correspondence Address: FAEGRE & BENSON LLP;PATENT DOCKETING, 2200 WELLS FARGO CENTER, MINNEAPOLIS, MN, 55402, US

(73) Assignee: Pella Corporation, Pella, IA (US)

(21) Appl. No.: 11/089,847

(22) Filed: Mar. 25, 2005

(51) Int. Cl. E06B 3/00

(52) U.S. Cl. 52/204.55

(57) ABSTRACT

An adjustable shim for positioning a closure unit in a rough opening. The closure unit includes a frame with a perimeter edge and at least one longitudinal recess in the perimeter edge. The adjustable shim includes an attachment member adapted to releasably couple with the longitudinal recess and at least one deformable leg having a first end and a second end coupled to the attachment member. An elongated member is coupled to the deformable leg in a compact configuration. Displacement of the elongated member in a first direction deforms the leg into an expanded configuration. The adjustable shim in the expanded configuration creates opposing forces simultaneously acting on the perimeter edge and the rough opening sufficient to suspend the closure unit in the rough opening. A method and system for installing a closure unit in a rough opening using the adjustable shim is also disclosed.

### FIELD OF THE INVENTION

The present invention is directed to an adjustable shim for positioning a closure unit in a rough opening, and in particular, to an installation system and method for a closure unit.

### BACKGROUND OF THE INVENTION

One of the more time consuming jobs in the construction and restoration fields is the setting (i.e. installing, leveling, and plumbing) of closures such as doors, windows, side lights, transoms, gable air vents, portals, skylights, etc., in rough structural openings, such as the rough opening 10 illustrated in FIG. 1. The rough opening 10 is slightly larger than the closure unit to facilitate installation.

Installers typically use wooden shims placed and sometime driven in the gap between the closure frame or jamb and the wall studs that form the rough opening. A level is used during this process to confirm the positioning of the jamb in the opening and re-adjustment of the shims is made as necessary to complete the installing, leveling and plumbing process. Levels are used on closures that have a flat vertical or horizontal side or sides. A plumb line is used on closures where a level is ineffective, such as a circular or oval closure.

Although the wooden shim is still the dominant means today for installing closures, it does have some limitations including: (1) the method of installing with wood shims is very time consuming; (2) wood shims are difficult to use on rounded surfaces (i.e. circular, oval-portals, stained glass ovals, etc.); (3) wood shims often interfere with complete sealing of the window to the rough opening; and (4) wood shims can slip out of place during installation of the closure unit.

U.S. Pat. No. 5,655,343 (Seals) discloses an adjustable shim that attaches to a window or a door jamb at the construction site. Flanges 160, 170 are bent around the jamb and attached thereto with fasteners. As best illustrated in FIG. 9, the flanges 160, 170 extend beyond the perimeter edge of the door.

U.S. Pat. No. 5,692,350 (Murphy, Jr.) discloses a spring shim for windows and doors. The spring shim of Murphy is in an expanded configuration prior to installation of the window or door in the rough opening.

U.S. Pat. Nos. 4,713,922 (Ingold); 4,731,965 (Jensen); 5,054,250 (Foss); and 6,018,916 (Henry) disclose variations on conventional shims.

### BRIEF SUMMARY OF THE INVENTION

The present invention is directed to an adjustable shim for positioning a closure unit in a rough opening. The present invention is also directed to an installation system and method for a closure unit.

One embodiment is directed to a system for installing a closure unit in a rough opening. The closure unit includes a frame with a perimeter edge and at least one longitudinal recess extending along at least a portion of the perimeter edge. An attachment member on an adjustable shim is releasably coupled with the longitudinal recess. The adjustable shim includes at least one deformable leg having a first end and a second end is coupled to the attachment member. An elongated member coupled to the deformable leg in a compact configuration such that displacement of the elongated member relative to the attachment member in a first direction deforms the deformable leg into an expanded configuration. The adjustable shim is substantially located within the perimeter edge of the closure unit in the expanded configuration. The elongated member can be notched strap, such as on a cable tie, a threaded member, or a variety of other structures adapted to apply a force on the deformable legs.

Another embodiment of the present invention is directed to a system for installing a closure unit in a rough opening. The closure unit has a frame with a perimeter edge and at least one longitudinal recess extending along at least a portion of the perimeter edge. An attachment member on the adjustable shim is releasably coupled with the longitudinal recess. The adjustable shim includes at least one deformable leg having a first end and a second end coupled to the attachment member and a threaded member coupled to the deformable leg in a compact configuration. Rotation of the threaded member in a first direction deforms the leg into an expanded configuration, wherein the adjustable shim is substantially retained within the perimeter edge in both the compact and expanded configurations.

The longitudinal recess preferably extends substantially around the perimeter edge of the closure unit. The attachment member preferably slidingly engages with the longitudinal recess. In one embodiment, the attachment member forms a snap-fit relationship with the longitudinal recess. At least one locking mechanism proximate the attachment member is optionally used to secure the adjustable shim relative to the longitudinal recess. The adjustable shim is preferably attached to the closure unit at a location remote from the rough opening, such as for example at a manufacturing facility.

The deformable leg can be elastically or plastically deformable. The deformable leg can be metal, plastic, or a composite thereof. In one embodiment, the deformable leg is a pair of deformable legs located on opposite sides of the threaded member. The deformable leg is preferably constructed from a sheet material.

Rotation of the threaded member in the first direction causes the first end to displace toward the second end. Rotation of the threaded member in a second direction opposite from the first direction causes the first end to displace away from the second end. The threaded member is preferably coupled proximate the first and second ends of the deformable leg. The threaded member includes at least one adjustment interface, such as for example a Phillips or hex headed member, at a distal end thereof. In the preferred embodiment, the adjustment interface is compatible with conventional tools, such as for example, flat-head or Phillips screwdrivers, hex-headed tools, and the like.

The adjustable shim is preferably located between an interior sealing plane and an exterior sealing plane associated with the closure unit. The adjustable shim is accessible through one or both of the interior or exterior sealing planes associated with the closure unit.

The adjustable shim in the expanded configuration creates opposing forces simultaneously acting on the perimeter edge of the closure unit and the rough opening. The expanded configuration spans the gap between the perimeter edge and the rough opening. The width of the closure unit and the adjustable shim in the compact configuration is preferably less than a width of the rough opening.

In one embodiment, finish trim is attached to an interior surface of the closure unit generally around the perimeter edge. A foam material can optionally be used to attach the closure unit to the rough opening.

The present invention is also directed to a method of installing a closure unit in a rough opening. A longitudinal recess is formed in at least a portion of a perimeter edge of a frame on the closure unit. An attachment member on an adjustable shim is releasably coupled to the longitudinal recess so that the adjustable shim is substantially retained within the perimeter edge. The adjustable shim is configured in a compact configuration. The closure unit is positioned in the rough opening. The adjustable shim is deformed to an expanded configuration that creates opposing forces simultaneously acting on the perimeter edge and the rough opening sufficient to suspend the closure unit in the rough opening.

The method typically includes attaching a plurality of adjustable shims to the closure unit at a manufacturing facility, prior to delivery of the closure unit to the installation site. The method optionally includes sliding the adjustable shim along the longitudinal recess to the desired location. Once the closure unit is suspended in the rough opening using the adjustable shims, the frame is attached to the rough opening using foam, fasteners, or a combination thereof.

In one embodiment, the method includes attaching finish trim to an interior surface of the closure unit generally around the perimeter edge before positioning the closure unit in the rough opening. The adjustable shim and/or finish trim is preferably attached to the closure unit at a remote location.

### BRIEF DESCRIPTION OF THE SEVERAL VIEWS OF THE DRAWING

FIG. 1 is a front view of a rough opening for receiving a closure unit.

FIG. 2 is a front view of a closure unit and a plurality of adjustable shims in accordance with the present invention.

FIG. 3a is a perspective view of an adjustable shim in accordance with an embodiment of the present invention.

FIG. 3b is a top view of the adjustable shim of FIG. 3a.

FIG. 3c is an end view of the adjustable shim of FIG. 3a.

FIG. 3d is an end view of the adjustable shim of FIG. 3a.

FIG. 4a is a side view of an adjustable shim in the compact configuration in accordance with the present invention.

FIG. 4b is a side view of the adjustable shim of FIG. 4a in an expanded configuration.

FIG. 5 is a top view of an alternate adjustable shim in accordance with the present invention.

FIG. 6a is a side view of an alternate adjustable shim in accordance with the present invention.

FIG. 6b is a side view of the alternate adjustable shim of FIG. 6a in a looped configuration.

FIG. 6c is an enlarged partial sectional view of the head and strap of FIG. 6a.

FIG. 7 is fragmentary cross-sectional view of a closure unit installed in a rough opening using an adjustable shim in accordance with the present invention.

FIG. 8 is a fragmentary cross-sectional view of a closure unit installed in a rough opening using an alternate adjustable shim in accordance with the present invention.

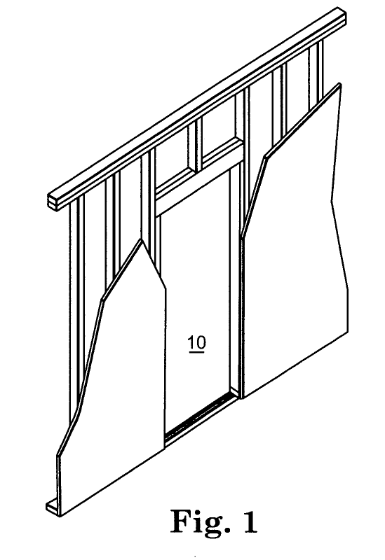

### DETAILED DESCRIPTION OF THE INVENTION

The present invention is directed to a system for installing a closure unit in a rough opening. The present system includes the use of an adjustable shim reliably attached to the closure unit, preferably at a remote location, such as a manufacturing facility. The remote location refers to any location other than the site of the rough opening. As used herein, “closure” or “closure unit” refer to a structure that mounts in a rough opening of a building structure, such as for example doors, fixed or movable windows, side lights, transoms, gable air vents, portals, skylights, and the like.

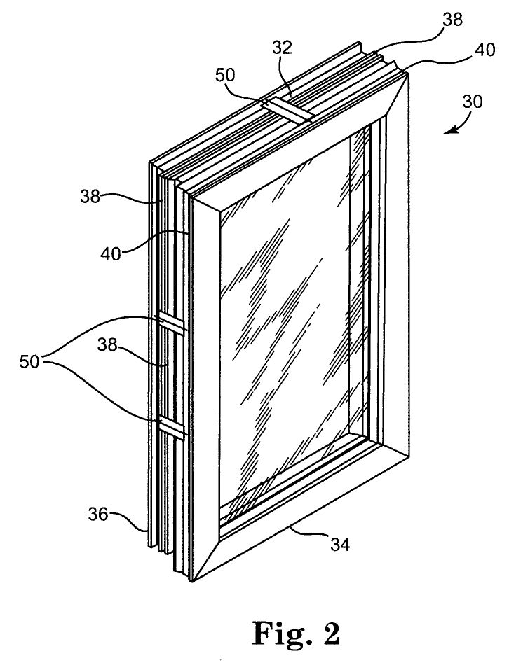

FIG. 2 illustrates an exemplary closure unit 30 for installation in the rough opening 10. The closure unit 30 includes a frame 32 with an exterior sealing plane 34 and an interior sealing plane 36. As used herein, “exterior sealing plane” refers to a plane extending across the generally outermost external surfaces of a closure unit. As used herein, “interior sealing plane” refers to a plane extending across the generally outermost internal surfaces of a closure unit.

Located generally between the exterior sealing plane 34 and the interior sealing plane 36 of the closure unit 30 is a perimeter edge 38. The perimeter edge 38 includes one or more surfaces on the perimeter of the closure unit 30 that extend between the exterior and interior sealing planes 34, 36. As used herein, “perimeter edge” refers to one or more surfaces located between interior and exterior sealing planes of a closure unit.

The perimeter edge 38 preferably includes one or more longitudinal recesses 40. One or more adjustable shims 50 are releasably attached or coupled to the longitudinal recess 40, preferably along each side of the closure unit 30. The adjustable shims 50 can preferably be attached and detached from the recess 40 without the use of tools. In one embodiment, the adjustable shims 50 are adapted to form a snap-fit relationship with the longitudinal recess 40.

In the preferred embodiment, the adjustable shims 50 are releasably attached to the closure unit 30 at a location remote from the rough opening 10, such as a manufacturing facility. The closure unit 30 is preferably packaged and shipped with the adjustable shims 50 pre-attached. Alternatively, some or all of the adjustable shims 50 can be snap-fit into the longitudinal recess 40 at the installation site.

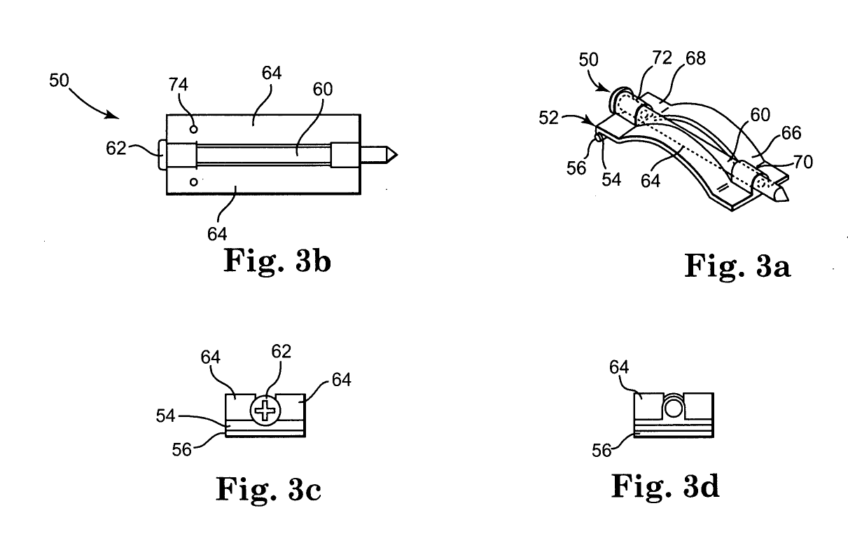

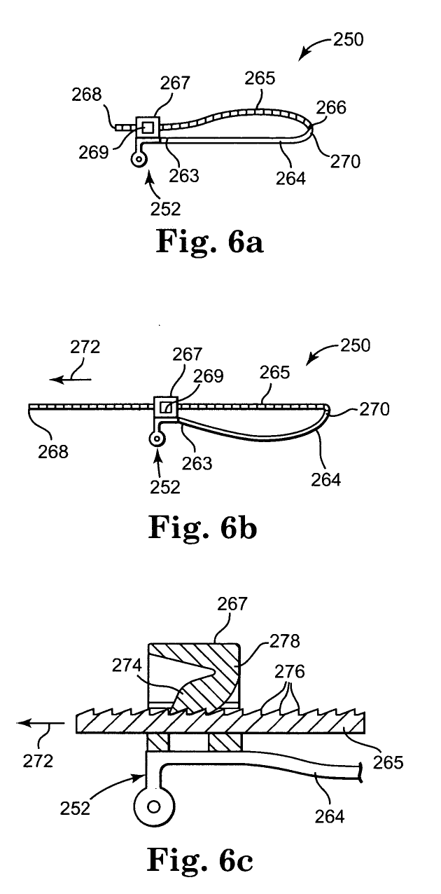

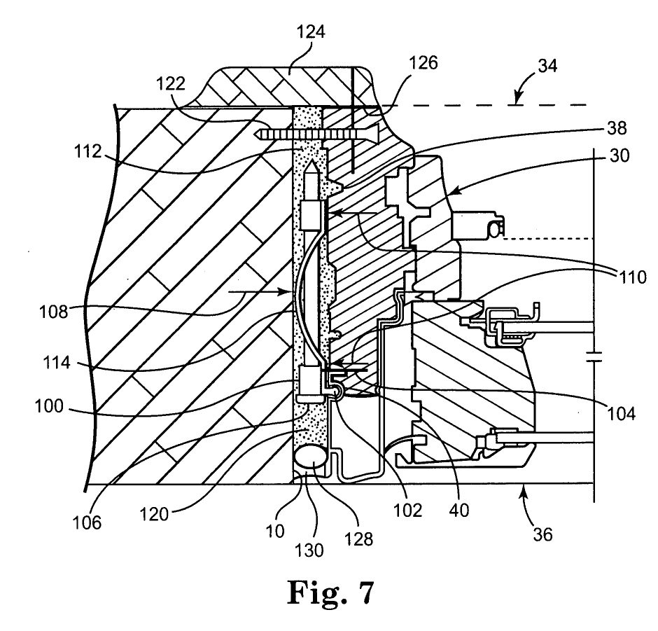

FIGS. 3a through 3d illustrate one embodiment of the adjustable shim 50 in accordance with the present invention. The adjustable shim 50 includes an attachment member 52. In the illustrated embodiment, the attachment member 52 includes a flange 54 with a rounded distal end 56. The attachment member 52 preferably forms a snap-fit relationship with the longitudinal recess 40 (See e.g., FIGS. 6 and 7).

In the preferred embodiment, the attachment member 52 permits the adjustable shim 50 to slidingly engage with the longitudinal recess 40. The sliding relationship between the longitudinal recess 40 and the attachment member 52 permits the installer to position the adjustable shims 50 at the optimum locations along the perimeter edge 38 to install the closure 30 in the rough opening 10. As used herein, “snap fit” refers to a positive engagement by substantially elastic deformation of two generally interengaging components.

The adjustable shim 50 includes elongated member 60 with an adjustment interface 62. In the illustrated embodiment, the elongated member 60 is a threaded member. The adjustment interface 62 may comprise a structure that can mechanically couple with a variety of specialty or conventional tools, such as for example a flat head screw drive, a Phillips screw drive, a torx wrench, a hex wrench, a socket wrench, and the like.

In the illustrated embodiment, the threaded member 60 includes a single adjustment interface 62 at a distal end of the threaded member 60. Alternatively, the threaded member 60 may include a first and second adjustment interfaces 62 at opposite ends from each other (see e.g., FIG. 5). Depending on the location of the adjustment interface 62, the adjustable shim 30 can be adjusted from one side or both sides of the adjustable shim 50.

Coupled to the threaded member 60 is at least one deformable leg 64 having a first end 66 and second end 68. The deformable leg 64 may be made of metal, plastic, fiberglass, or a composite thereof. The deformable leg 64 is preferably formed from a sheet material. The deformable leg 64 is either elastically or plastically deformable.

In the illustrated embodiment, sleeve 70 is attached to the deformable leg 64 near the first end 66 and sleeve 72 is attached to the deformable leg 64 near the second end. In the illustrated embodiment, the sleeve 70 has internal threads that correspond to the threads on the threaded member 60. Alternatively, the sleeve 72 can include internal threads.

FIG. 3b illustrates a positioning mechanism 74 proximate the attachment member 52. The positioning mechanism 74 is optionally used to secure the adjustable shim 50 to the closure unit 30 at a particular location along the longitudinal recess 40. In the illustrated embodiment, the positioning mechanism 74 includes a pair of holes, which can receive nails, screws, or the like. Alternatively, the positioning member 74 can be a pointed protrusion stamped through the second end 68.

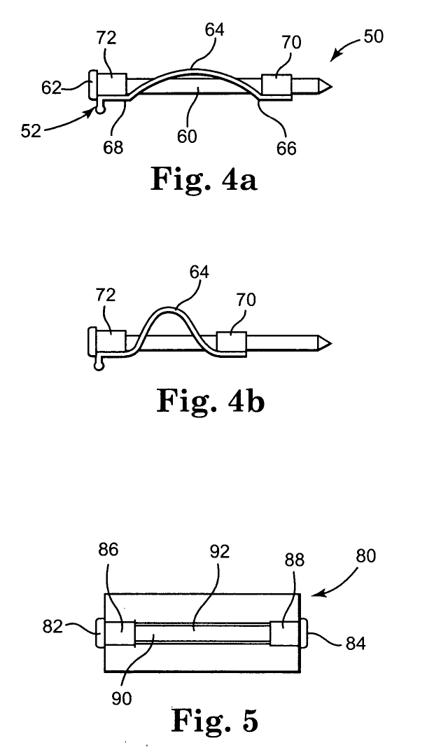

FIGS. 4a and 4b illustrate operation of the adjustable shim 50 in accordance with the present invention. Prior to operation, the legs 64 are in a substantially compact configuration, as illustrated in FIG. 4a. The compact configuration refers to the legs 64 in a generally elongated configuration so that the adjustable shim 50 is thinner or flatter than in the expanded configuration.

Rotation of the adjustment interface 62 causes the threaded member 60 to rotate in the threaded sleeve 70. Since rotation of the threaded sleeve 70 is restricted by the legs 64, rotation of the threaded member 60 in the first direction causes the first end 66 to displace toward the second end 68. As best illustrated in FIG. 4b, the displacement of the threaded sleeve 70 causes the leg 64 to deform to an expanded configuration. Rotation of the threaded member 60 in a second direction opposite the first direction causes the first end 66 to be displaced in the opposite direction, causing the leg 64 to move toward a compact configuration illustrated in FIG. 4a.

FIG. 5 illustrates an alternate adjustable shim 80 with an adjustment interface 82, 84 located at each end, in accordance with the present invention. One sleeve 86, 88 preferably have internal threads. In another embodiment, the sleeve 86 has left-handed threads and the sleeve 88 has right-handed threads so that rotation of the threaded member 90 causes the sleeves to simultaneously move toward or away from center region 92.

FIG. 6a illustrates yet another embodiment of the adjustable shim 250 in accordance with the present invention. In the illustrated embodiment, the adjustable shim 250 includes an attachment member 252 connected at a first end 263 of a deformable leg 264. First end 266 of elongated member or strap 265 is coupled to second end 270 of the deformable leg 264. Second end 268 of the strap 265 is slidingly engaged in opening 269 in head 267. The head 267 may be attached to the attachment member 252 by adhesives, welding, fasteners or a variety of other techniques. Alternatively, the attachment member 252 may be integrally molded with the head 267 as a single component.

As best illustrated in the enlarged partial sectional view of FIG. 6c, the elongated strap 265 includes a plurality of notches, teeth or serrations 276, on one or both sides, that engage with locking tab 274. The locking tab 274 is preferably configured to allow the strap 265 to move in direction 272 and to prevent movement in the other direction. In the illustrated embodiment, the locking tab 274 is integrally formed with the head 267. A living hinge 278 connects the locking tab 274 to the head 267. The present head 267 and strap 265 may be a conventional cable tie structure, such as disclosed in U.S. Pat. No. 5,675,870 (Cooper), which is hereby incorporated by reference. Alternatively, the head 267 may be configured for releasable engagement with the strap 265, to reduce tension on the deformable leg 264, such as disclosed in U.S. Pat. No. 6,185,792 (Nelson, et al.), which is hereby incorporated by reference. The head 267 and strap 265 may be formed from plastic, nylon, metal or other light, but suitable materials.

FIG. 6b illustrates the operation of the adjustable shim 250. Prior to operation, the deformable leg 264 is preferably in a compact configuration, such as illustrated in FIG. 6a. The attachment member 252 is releasably attached to the longitudinal recess 40 on the closure unit 30. With the head 267 fixed to the closure unit 30 (see FIG. 2), the free end 268 of the strap 265 is pulled in the direction 272, causing the deformable leg 264 to deform to an expanded configuration, such as illustrated in FIGS. 4b and 6b. The strap 265 can optionally be pulled manually or with the assistance of a tool. The strap 265 is preferably trimmed so that it does not extend through the exterior or interior sealing planes 34, 36.

FIG. 7 is a cross-sectional view of the closure unit 30 installed in a rough opening 10 using an adjustable shim 100 in accordance with the present invention. Attachment member 102 preferably forms a snap-fit relationship with the longitudinal recess 40 on the closure unit 30. In the preferred embodiment, the adjustable shim 100 is releasably attached to the recess 40 without the use of fastener. In one embodiment, friction between the attachment member 102 and the longitudinal recess 40 is sufficient to retain the adjustable shim 100 in the desired location. In one embodiment, the attachment member 102 is coated with a material that increases friction with the longitudinal recess 40. Alternatively, an adhesive can be used to secure the adjustable shim 100 along the longitudinal recess 40. The adhesive preferably has sufficient adhesion to retain the adjustable shim 100 to the recess 40, while permitting the adjustable shim 100 to be removed manually without the use of tools. In another embodiment, fasteners 104, such as finishing nail, can optionally be used to secure the adjustable shim 100 at a particular location along the longitudinal recess 40.

Rotation of the adjustment interface 106 causes the adjustable shim 100 to expand, creating opposing forces 108, 110 between the rough opening 10 and the perimeter edge 38 of the closure unit 30. The opposing forces 108, 110 operate to suspend the closure unit 30 in the desired position within the rough opening 10. A plurality of adjustable shims 100 are preferably adjusted until the closure unit 30 is properly positioned, level and tightly secured in the rough opening 10. The legs 114 of the adjustable shim 100 are preferably elastically deformable so that the installer can reduce the forces 108, 110 by counter-rotating the adjustment interface as needed. Alternatively, the legs 114 are plastically deformable.

The adjustable shims 100 are preferably located between the exterior sealing plane 34 and the interior sealing plane 36. Consequently, the present adjustable shims 100 do not interfere with whatever sealing material is positioned in the gap 112 between the perimeter edge 38 and the rough opening 10. In one embodiment, foam material 120 is sprayed into the gap 112 to form a weather-tight seal and/or to securely attach the closure unit 30 in the rough opening 10. As illustrated in FIG. 7, the adjustable shim 100 does not interfere with the sealing function of the foam 120. Conventional fasteners 122 can also be used to secure the closure unit 30 to the rough opening 10. In another embodiment, backer rod 128 is located in the gap 112. Caulking 130 forms a seal between the rough opening 10 and the perimeter edge 38 of the closure unit 30 along the exterior surface of the backer rod 128.

In the illustrated embodiment, the closure unit 30 further includes a finish trim 124 attached to an interior surface 126 of the closure unit 30, generally around the perimeter edge 38. The finish trim 124 is preferably attached to the interior surface 126 at location remote from the rough opening 10 prior to installation of the closure unit 30, such as a manufacturing factory. This embodiments permits the finish trim 124 to be factory installed and a factory finish applied prior to the closure unit 30 being shipped to the installation site.

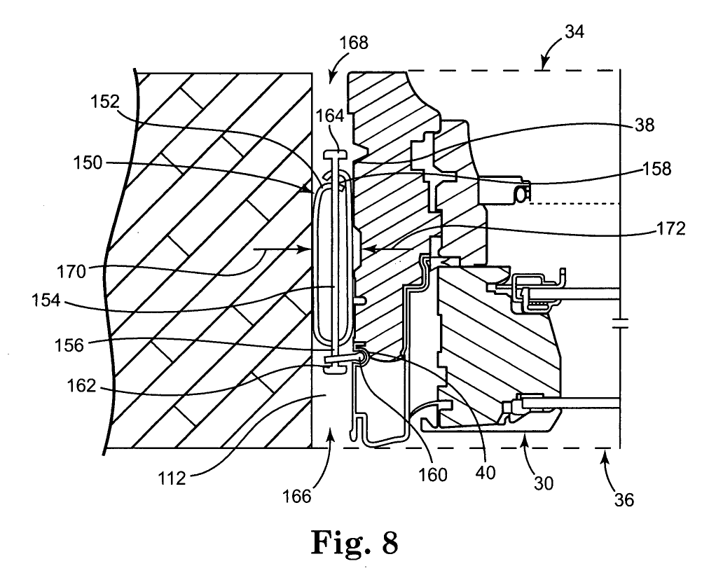

FIG. 8 illustrates a cross-sectional view of another embodiment of the adjustable shim 150 in accordance with the present invention. The adjustable shim 150 is constructed from a band of coiled material 152 threadably engaged with threaded member 154. The coiled material 152 preferably has threads only at the location 156 or 158. An attachment mechanism 160 slidingly engaged with the longitudinal recess 40 on the perimeter edge 38 of the closure unit 30.

In the illustrated embodiment, the threaded member 154 has an adjustment interface 162, 164 at each end. This configuration permits the installer to operate the adjustable shim 150 from either the inside 166 or outside 168 of the closure unit 30.

Rotation of the threaded member 154 causes the coiled material 152 to deform to an expanded configuration, which creates opposing compressive forces 170, 172 between the outer perimeter 38 and the rough opening 10.

Again, the adjustable shims 150 are preferably located between the exterior sealing plane 34 and the interior sealing plane 36. Consequently, the present adjustable shims 150 do not interfere with whatever sealing material is positioned in the gap 112 between the perimeter edge 38 and the rough opening 10. The adjustable shim 250 of FIGS. 6a-6c may be used with either of the embodiments in FIGS. 7 and 8.

Patents and patent applications disclosed herein, including those cited in the Background of the Invention, are hereby incorporated by reference. Other embodiments of the invention are possible. It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A system for installing a closure unit in a rough opening comprising:
a closure unit having a frame with a perimeter edge and at least one longitudinal recess extending along at least a portion of the perimeter edge;
an adjustable shim comprising;
an attachment member releasably coupled with the longitudinal recess;
at least one deformable leg having a first end and a second end coupled to the attachment member; and
an elongated member coupled to the deformable leg in a compact configuration such that displacement of the elongated member relative to the attachment member in a first direction deforms the deformable leg into an expanded configuration, wherein the adjustable shim is substantially located within the perimeter edge in the expanded configuration.

2. The system of claim 1 wherein the attachment member slidingly engages with the longitudinal recess.

3. The system of claim 1 wherein the attachment member forms a snap-fit relationship with the longitudinal recess.

4. The system of claim 1 comprising at least one locking mechanism proximate the attachment member securing the adjustable shim relative to the longitudinal recess.

5. The system of claim 1 wherein the deformable leg is one of elastically deformable or plastically deformable.

6. The system of claim 1 wherein the deformable leg comprises one of metal, plastic, or a composite thereof.

7. The system of claim 1 wherein the at least one deformable leg comprises a pair of deformable legs located on opposite sides of the elongated member.

8. The system of claim 1 wherein the at least one deformable leg comprises a sheet material.

9. The system of claim 1 wherein the elongated member comprises a notched strap.

10. The system of claim 9 wherein the notched strap slidingly engages with a head on the attachment member.

11. The system of claim 9 wherein the notched strap slidingly engages in only one direction with a head on the attachment member.

12. The system of claim 1 wherein the elongated member comprises a threaded member.

13. The system of claim 1 wherein displacement of the elongated member in the first direction causes the first end of the deformable leg to be displaced toward the second end.

14. The system of claim 1 wherein displacement of the elongated member in a second direction opposite from the first direction causes the first end to displace away from the second end.

15. The system of claim 1 wherein the elongated member is coupled to the deformable leg proximate the first and second ends of the deformable leg.

16. The system of claim 1 wherein the adjustable shim in the compact configuration is located substantially within the perimeter edge of the closure unit.

17. The system of claim 1 wherein the adjustable shim is accessible through one or more of an interior sealing plane and an exterior sealing plane associated with the closure unit.

18. The system of claim 1 wherein the elongated member comprises at least one adjustment interface at a distal end thereof.

19. The system of claim 1 wherein the expanded configuration creates opposing forces simultaneously acting on the perimeter edge and the rough opening.

20. The system of claim 1 wherein the deformable leg in the expanded configuration spans a gap between the perimeter edge and the rough opening.

21. The system of claim 1 wherein a width of the closure unit and the adjustable shim in the compact configuration is less than a width of the rough opening.

22. The system of claim 1 comprising finish trim attached to an interior surface of the closure unit generally around the perimeter edge.

23. The system of claim 1 comprising a foam material adapted to attached the closure unit to the rough opening.

24. The system of claim 1 wherein the adjustable shim is attached to the closure unit at a location remote from the rough opening.

25. A method of installing a closure unit in a rough opening, comprising the steps of:
forming a longitudinal recess in at least a portion of a perimeter edge of a frame on the closure unit;
releasably coupling an attachment member of an adjustable shim to the longitudinal recess so that the adjustable shim is substantially located within a perimeter edge of the closure unit;
configuring the adjustable shim in a generally compact configuration;
positioning the closure unit in the rough opening; and
displacing an elongated member on the adjustable shim in a first direction relative to the attachment member to deform the adjustable shim into an expanded configuration, the adjustable shim in the expanded configuration creating opposing forces simultaneously acting on the perimeter edge and the rough opening sufficient to suspend the closure unit in the rough opening.

26. The method of claim 25 comprising the step of slidably positioning the adjustable shim in the compact configuration along the longitudinal recess.

27. The method of claim 25 comprising the step of attaching finish trim to an interior surface of the closure unit generally around the perimeter edge before positioning the closure unit in the rough opening.

28. The method of claim 27 wherein the finish trim is attached to the closure unit at a remote location.

29. The method of claim 25 comprising releasably attaching the adjustable shim to the longitudinal recess at a remote location.

30. An adjustable shim for positioning a closure unit in a rough opening, the closure unit including a frame with a perimeter edge and at least one longitudinal recess in the perimeter edge, the adjustable shim comprising:
an attachment member releasably coupled with the longitudinal recess;
at least one deformable leg having a first end and a second end coupled to the attachment member; and
an elongated member coupled to the deformable leg in a compact configuration such that displacement of the elongated member relative to the attachment member in a first direction deforms the deformable leg into an expanded configuration, wherein the adjustable shim is substantially located within the perimeter edge in the expanded configuration.
